(19) United States
(12) Patent Application Publication
(10) Pub. No.: US 2009/0267539 A1
(43) Pub. Date: Oct. 29, 2009

(54) BACKLIGHT MODULE

(75) Inventors: Ming Feng Liu, Taoyuan (TW); Ching Chang Hsien, Taoyuan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp., Taoyuan (TW)

(21) Appl. No.: 12/413,249

(22) Filed: Mar. 27, 2009

(30) Foreign Application Priority Data
Apr. 23, 2008 (TW) 097206962

(51) Int. Cl. H05B 37/02

(52) U.S. Cl. 315/297

(57) ABSTRACT

The invention provides a backlight module comprising a plurality of lighting units and at least one balance transformer. Each of the lighting units comprises a first electrode terminal and a second electrode terminal, and the first electrode terminals are coupled to a power source. The at least one balance transformer is coupled to at least one of the second electrode terminals. The primary side of the at least one balance transformer could be connected to each other to form a close loop. Accordingly, the backlight module could be used for large size panel.

### BACKGROUND OF THE INVENTION

1. Field of the Invention

The present invention relates to a backlight module, and more particularly, to a backlight module which is suitable for a large-scale Liquid Crystal Display (LCD) panel.

2. Description of the Prior Art

In recent years, with the increases of size of the Liquid Crystal Display (LCD) panel, a backlight apparatus comprising a plurality of Cold Cathode Fluorescent Lamps (CCFL) is widely utilized to provide the high quality light source needed by the LCD panel.

A critical problem for the multi-lamp backlight apparatus is: How to make the current that goes through every lamp to be approximately maintained equal, so as to make sure that the light source provided to the liquid crystal display panel has stable and homogeneous brightness. In the prior art, a method was disclosed by using at least one balance transformer which is disposed between the power source and each of the lamps, wherein one end of the secondary-side coil of the balance transformer is coupled to the power source and the other end is coupled to an electrode terminal of a lamp, and then the primary-side coil of each balance transformer is connected to each other in series. With the aforementioned balance transformers, the currents between the lamps are balanced and their differences are not too big to cause a user to be conscious of non-equal brightness when the user watches the LCD panel.

Please refer to FIG. 1. FIG. 1 is a schematic diagram illustrating that balance transformers 10 balance the currents passing through lamps 12 according to prior art. As shown in FIG. 1, each of the balance transformers 10 comprises a primary-side coil 100 and a secondary-side coil 102. Each of the secondary-side coils 102 has a first end 1020 and a second end 1022, wherein each of the first ends 1020 is coupled to one of the lamps 12 and the second ends 1022 are coupled respectively to power sources 14 and 16 with different polarities. Each of the primary-side coils 100 is connected to each other in series to form a close loop. In addition, the close loop is further coupled to a feedback circuit 1000. In practice, the feedback circuit 1000 can sense the current of the close loop and control a return circuit to send a return signal to a circuit board to control the power source accordingly, so as to achieve the functions of trimming voltage and feedback circuit.

However, besides the number of the lamps, the length of each of the lamps also needs to be increased to make sure that each section of the panel has enough illumination when the scale of the LCD panel increases. When the length of the lamp is longer, the voltage added on the electrode terminal of the lamp also increases in order to drive the lamp to light. Therefore, the balance transformer in the prior art also needs higher voltage endurance to make sure that the balance transformer will not be destroyed under the high voltage provided by the power source, and that will increase the manufacturing cost. Besides, because the comparatively bigger volume of the balance transformer with higher voltage endurance, it is unfavorable for the thinning of the LCD panel.

On the other hand, because the lamps of the large-scale LCD panel are longer and the parasitic capacitances of the lamps are different, the current balance effect provided by the balance transformer in the prior art is not good enough for the end of the lamp far away from the balance transformer, and it will result in the inhomogeneous lightening of the LCD panel. Besides, in the large-scale LCD panel, the existent frame of bipolar power sources needs a double-plates circuit board to dispose the power sources with different polarities, so as to prevent the insufficiency of the insulation distance. However, using double plates in the large-scale panel will raise its production cost.

### SUMMARY OF THE INVENTION

Therefore, an aspect of the present invention is to provide a backlight module with a balance transformer which allows lower voltage endurance to solve the aforementioned problem.

According to an embodiment, the backlight module of the invention comprises a plurality of lighting units and at least one balance transformer. Each of the lighting units comprises a first electrode terminal and a second electrode terminal corresponding to the first electrode terminal, and the lighting unit can be driven according to the voltage drop between the two electrode terminals, wherein the first electrode terminal could be coupled to a power source. The at least one balance transformer is coupled to at least one of the second electrode terminals, and the primary sides of the at least one balance transformer could be connected to each other to form a close loop. Accordingly, the currents of each of the lighting units could be balanced.

In the embodiment, the close loop is further coupled to a feedback circuit. The feedback circuit can sense the current of the close loop, feedback the sensing result to the circuit board to control the voltage provided by the power source, and then protects the whole circuit frame.

Another aspect of the present invention is to provide a backlight module for driving the lighting units by unipolar power source.

According to an embodiment, the backlight module of the invention comprises a plurality of lighting units and at least one balance transformer. The secondary side of the balance transformer comprises a first end coupled to one of the first electrode terminals of the lighting units and a second end coupled to the unipolar power source. Each of the primary sides of the balance transformers is connected to each other in series to form the close loop, so as to balance the currents between the lighting units.

Another aspect of the present invention is to provide a backlight module, and two electrode terminals of the lighting unit of the backlight module are added to power sources with different polarities to drive the lighting unit.

According to an embodiment, the backlight of the invention comprises a plurality of lighting units and at least one balance transformer. Each of the lighting units comprises a first electrode terminal and a second electrode terminal, wherein each of the first electrode terminals is coupled to a first power source. The balance transformer comprises a primary side and a secondary side corresponding to the primary side, wherein the secondary side comprises a first end coupled to one of the second electrode terminals and a second end coupled to the second power source. Similarly, each of the primary sides is connected to each other in series to form the close loop, so as to balance the currents between the lighting units. In this embodiment, the polarity of the first power source is opposite to the polarity of the second power source, the first and the second electrode terminal of each the lighting units are staggered.

The objective of the present invention will no doubt become obvious to those of ordinary skill in the art after reading the following detailed description of the preferred embodiment, which is illustrated in the following figures and drawings.

### BRIEF DESCRIPTION OF THE APPENDED DRAWINGS

FIG. 1 is a schematic diagram illustrating that balance transformers balance the current passing through lamps according to prior art.

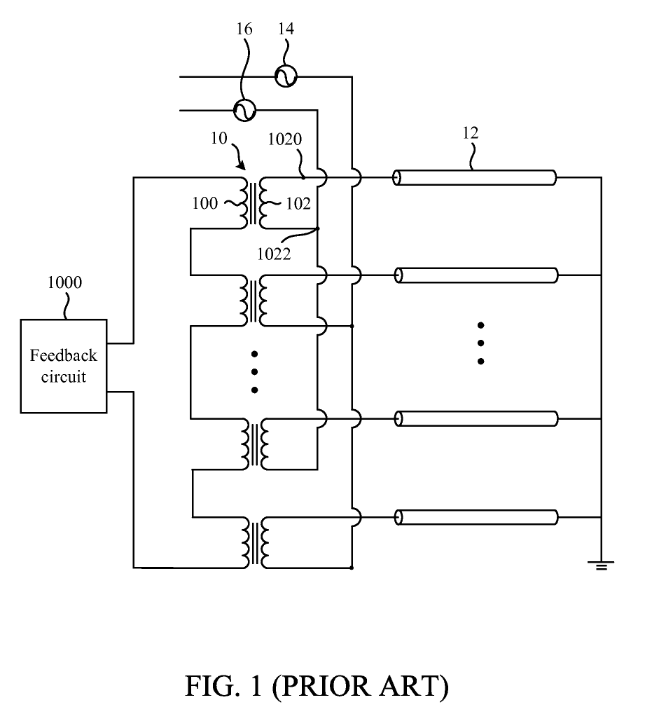

FIG. 2 is a schematic diagram illustrating a backlight module according to an embodiment of the invention.

FIG. 3 is a schematic diagram illustrating the backlight module according to another embodiment of the invention.

FIG. 4 is a schematic diagram illustrating the backlight module according to another embodiment of the invention.

FIG. 5 is a schematic diagram illustrating a backlight module according to an embodiment of the invention.

FIG. 6 is a schematic diagram illustrating the backlight module according to another embodiment of the invention.

FIG. 7 is a schematic diagram illustrating the backlight module according to another embodiment of the invention.

FIG. 8 is a schematic diagram illustrating the backlight module according to another embodiment of the invention.

FIG. 9 is a schematic diagram illustrating a backlight module according to an embodiment of the invention.

### DETAILED DESCRIPTION OF THE INVENTION

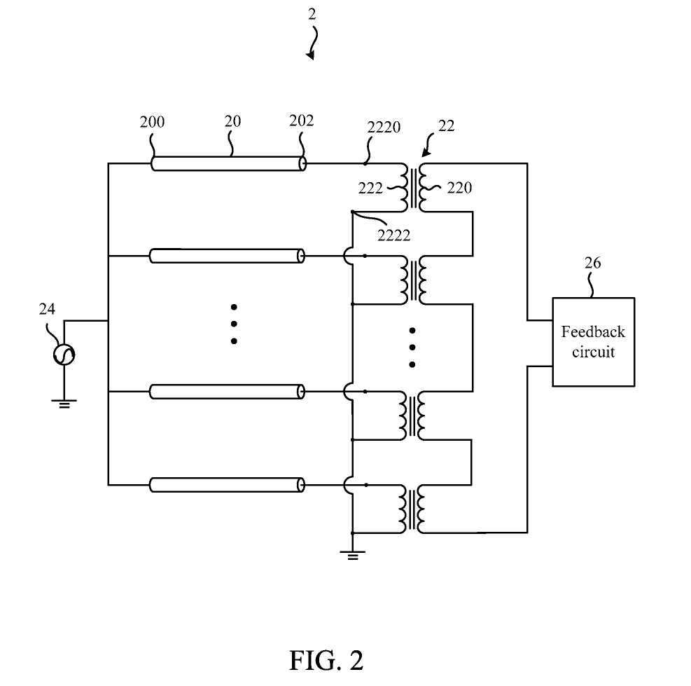

Please refer to FIG. 2. FIG. 2 is a schematic diagram illustrating a backlight module 2 according to an embodiment of the invention. As shown in FIG. 2, the backlight module 2 comprises a plurality of lighting units 20 and at least one balance transformer 22. It should be noted that the number of the balance transformers 22 in the embodiment is equal to the number of the lighting units 20. But in practice, the number of the balance transformers 22 is dependent on the demand of the user or the designer but not limited to the embodiment listed in the specification. Besides, in practice, the lighting unit 20 can be a lamp or other suitable lighting units.

In the embodiment, each of the lighting units 20 comprises a first electrode terminal 200 and a second electrode terminal 202. Each of the first electrode terminals 200 is coupled to a power source 24, and each of the second electrode terminals 202 is coupled to one of the balance transformers 22. Each of the at least one balance transformer 22 comprises a primary-side coil 220 and a secondary-side coil 222. Each of the secondary-side coils 222 further comprises a first end 2220 and a second end 2222, wherein the first end 2220 is coupled to one of the second electrode terminals 202 and the second end 2222 is grounded. Each of the primary-side coils 220 is connected to each other to form a close loop. The close loop is further coupled to a feedback circuit 26. Accordingly, the at least one balance transformer 22 can balance the currents between the lighting units 20 and make the optical intensity of each the lighting units are approximately equal.

The balance transformer 22 of the backlight module 2 in the embodiment is disposed on the second electrode terminal 202 of the lighting unit 20 to balance the current of the lighting unit 20, but not being coupled to the power source 24 directly, i.e. the balance transformer 22 is disposed on the low-voltage terminal of the lighting unit 20. The accepted voltage of the balance transformer 22 in the embodiment is lower than that in the prior art. Therefore, the transformer with lower voltage endurance and smaller size can be used to perform as the balance transformer 22.

It should be noted that, in practice, a balance transformer may comprise a plurality of secondary-side coils, and the first end of each of the secondary-side coils is coupled to the second electrode of a lighting unit. Accordingly, one balance transformer could be used to balance a plurality of lighting units. In addition, in practice, the feedback circuit can sense the current signal of the close loop, and then control a return circuit (not shown in the figure) to send a return signal to a circuit board (not shown in the figure) according to the current signal, so as to adjust the value of provided power in an acceptable range for the circuit frame in the embodiment.

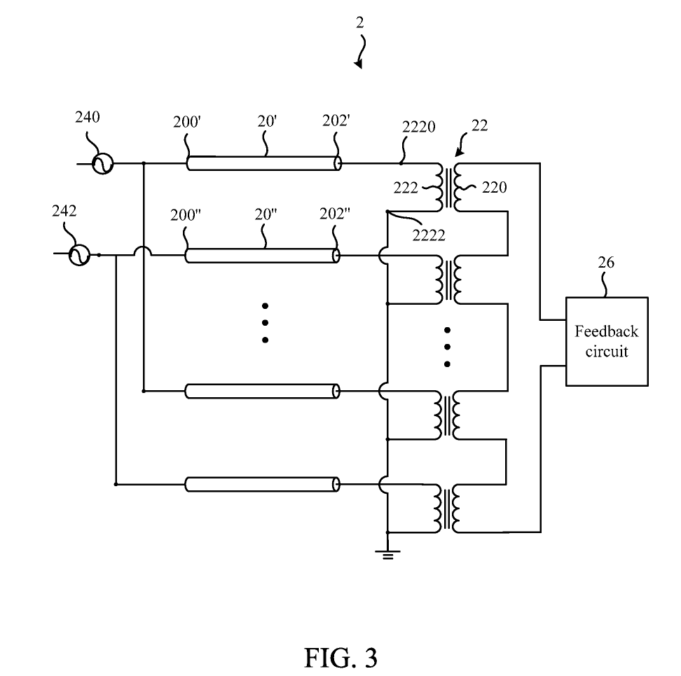

Please refer to FIG. 3. FIG. 3 is a schematic diagram illustrating the backlight module 2 according to another embodiment of the invention. As shown in FIG. 3, the difference between the embodiment and the prior embodiment is that the power source 24 in the embodiment further comprises a first power source 240 and a second power source 242, wherein the first power source 240 and the second power source 242 are power sources with different polarities.

In the embodiment, the first electrode terminals 200 of the lighting units 20 are coupled to the first power source 240 and the second power source 242 respectively, i.e. the lighting units 20 can be divided into first lighting units 20′ and second lighting units 20″ whose first electrode terminals 200′ and 200″ are coupled to the first power source 240 and the second power source 242 respectively. Besides, the second electrode terminals 202′ and 202″ of the first lighting units 20′ and the second lighting units 20″ are coupled to one of the first ends 2220 of the balance transformers 22 respectively, and the second ends 2222 of the transformers 22 are grounded. Similarly, the balance transformers 22 in the embodiment are coupled to low-voltage terminal of each of the lighting units 20 but not coupled to the power source directly. Therefore, the transformer with lower voltage endurance and smaller size can be used as the balance transformer 22.

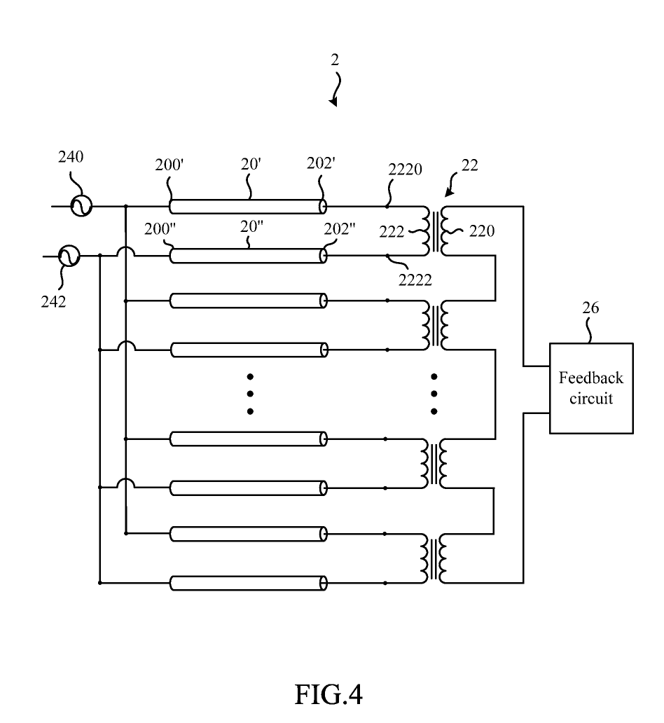

Please refer to FIG. 4. FIG. 4 is a schematic diagram illustrating the backlight module 2 according to another embodiment of the invention. As shown in FIG. 4, the difference between the embodiment and the prior embodiment is that the first end 2220 of the balance transformer 22 in the embodiment is coupled to the second electrode terminal 202′ of the first lighting unit 20′, and the second end 2222 is coupled to the second electrode terminal 202″ of the second lighting unit 20″.

In the embodiment, when the first power source 240 provides positive power and the second power source 242 provides negative power, the current flows in order from the first power source 240 through the first electrode terminal 200′, the second electrode terminal 202′, the first end 2220, the second end 2222, the second electrode terminal 202″, and the first electrode terminal 200″ to the second power source 242, so as to drive the first lighting unit 20′ and the second lighting unit 20″ to lighten. Hence, in the embodiment, a balance transformer 22 could be coupled to two lighting units 20 and balance their currents, and then the number of the balance transformers 22 required by the backlight module 2 can decrease. Besides, because the balance transformers 22 are coupled to low-voltage terminals of the first lighting unit 20′ and the second lighting unit 20″ but not coupled to the power source directly, the received voltage for the balance transformer 22 is lower than that of the prior art. Therefore, the transformer with lower voltage endurance and smaller size can be used as the balance transformer 22.

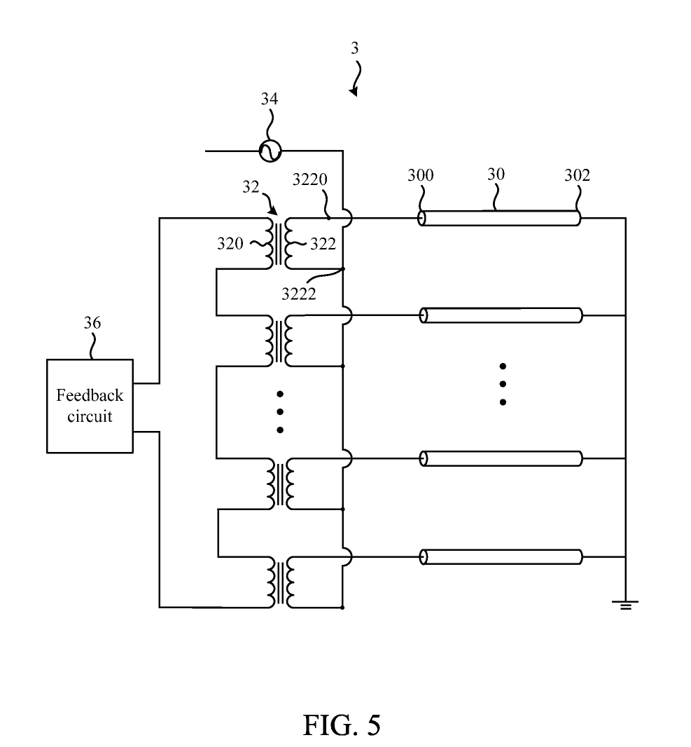

Please refer to FIG. 5. FIG. 5 is a schematic diagram illustrating a backlight module 3 according to an embodiment of the invention. As shown in FIG. 5, the backlight module 3 comprises a plurality of lighting units 30 and at least one first balance transformer 32, wherein the at least one first balance transformer 32 is coupled to a first power source 34 and the lighting unit 30. It should be noted that the number of the first balance transformers 32 in the embodiment is equal to the number of the lighting units 30. But in practice, the number of the first balance transformers 32 is dependent on the demand of the user or the designer, but not limited to the embodiment listed in the specification.

In the embodiment, the at least one first balance transformer 32 comprises a primary-side coil 320 and a secondary-side coil 322, wherein the secondary-side coil 322 further comprises a first end 3220 and a second end 3222. The first end 3220 is coupled to a first electrode terminal 300 of the lighting unit 30, and the second end 3222 is coupled to the first power source 34. Besides, each of the primary-side coils 320 is connected to each other to form a close loop, and the second electrode terminal 302 of the lighting unit 30 is grounded. Accordingly, the first balance transformer 32 in the embodiment can balance the currents between the lighting units 30 and the brightness of each of the lighting units 30 is approximately equal. Because the backlight module 3 in the embodiment uses a unipolar power source (the first power source 30) to drive the lighting unit 30, a single plate can be used as the substrate to lower the manufacturing cost practically.

In the embodiment, the close loop is further coupled to a feedback circuit 36. In practice, the feedback circuit 36 can sense the current signal of the close loop, and control a return circuit (not shown in the figure) to send a return signal to a circuit board (not shown in the figure) according to the current signal, so as to adjust the value of provided power in an acceptable range for the circuit frame in the embodiment.

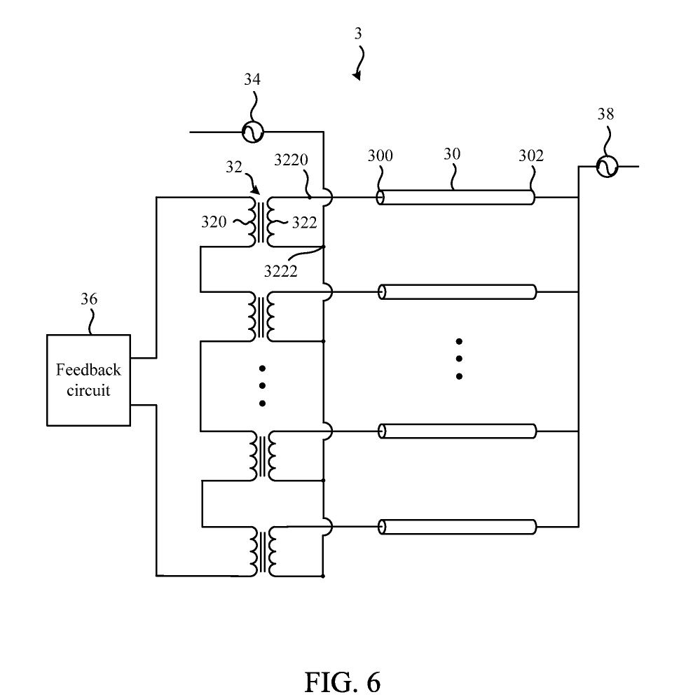

Please refer to FIG. 6. FIG. 6 is a schematic diagram illustrating the backlight module 3 according to another embodiment of the invention. As shown in FIG. 6, the difference between the embodiment and the last embodiment is that the second electrode terminal 302 of the lighting unit 30 in the embodiment is coupled to a second power source 38. The first power source 34 and the second power source 38 are power sources with different polarities.

In the embodiment, the first power source 34 and the first balance transformer 32 are coupled to the first electrode terminal 300 of the lighting unit 30, and the second power source 38 is coupled to the second electrode terminal 302 of the lighting unit 30. Because the different polarities of the first power source 34 and the second power source 38 are coupled to different electrode terminals of the lighting unit 30, in practice, positive circuit and negative circuit of the substrate could be set respectively to the two ends of the lighting unit 30 to prevent the problem of insufficient insulation distance. Therefore, a single plate can be used as the substrate to lower the production cost.

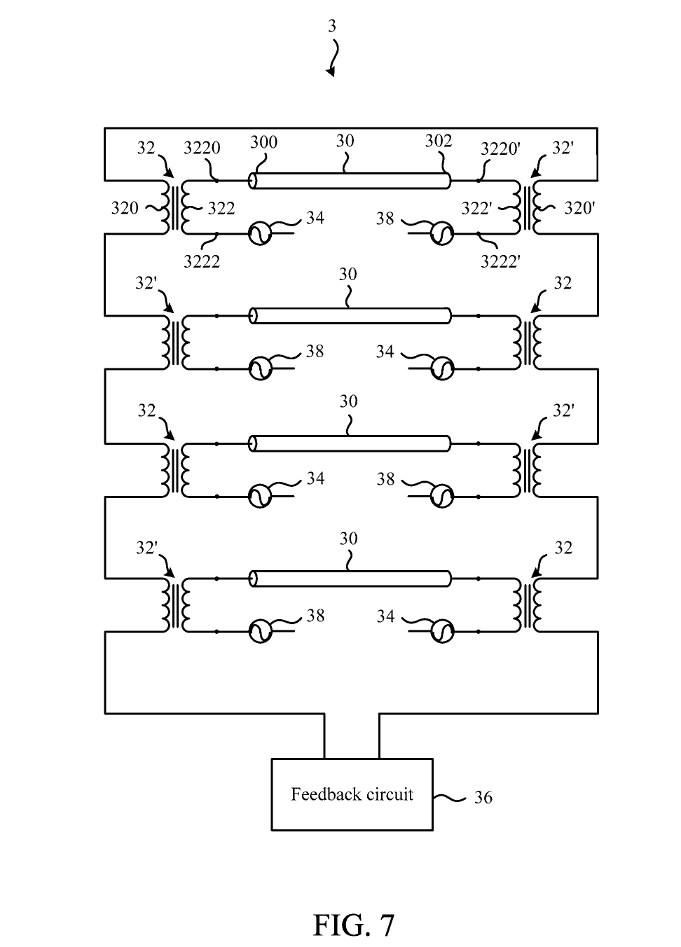

Please refer to FIG. 7. FIG. 7 is a schematic diagram illustrating the backlight module 3 according to another embodiment of the invention. As shown in FIG. 7, the difference between the embodiment and the prior embodiment is that the backlight module 3 in the embodiment further comprises at least one second balance transformer 32′. The second balance transformer 32′ comprises a primary-side coil 320′ and a secondary-side coil 322′, wherein the secondary-side coil 322′ further comprises a third end 3220′ and a fourth end 3222′. The third end 3220′ is coupled to one of the second electrode terminals 302 of the lighting units 30, and the fourth end 3222′ is coupled to the second power source 38. Similarly, the primary-side coil 320′ of each of the at least one second balance transformer 32′ and the primary-side coil 320 of each of the at least one first balance transformer 32 are connected to each other to form a close loop, and the close loop is further coupled to a feedback circuit 36.

In the embodiment, both the two electrode terminals (first electrode terminal 300 and the second electrode terminal 302) of the lighting unit 30 connect the balance transformers (the first balance transformer 32 and the second balance transformer 32′) and the power sources (the first power source 34 and the second power source 38). Therefore, both ends of the lighting unit 30 have the effect of current balance, and in practice, the better balance of brightness can be provided to each of the lighting units. In addition, in the embodiment, because the lighting units are staggered, double plates are needed to be used as the substrate. It should be noted that the detailed structure is shown with one unit only in the picture for clarity. However, in practice, the positive circuit and the negative circuit of the lighting unit also can be set respectively to the two ends of the lighting unit, so as to prevent the problem of insufficient insulation distance. Therefore, a single plate can be used as the substrate to lower the production cost.

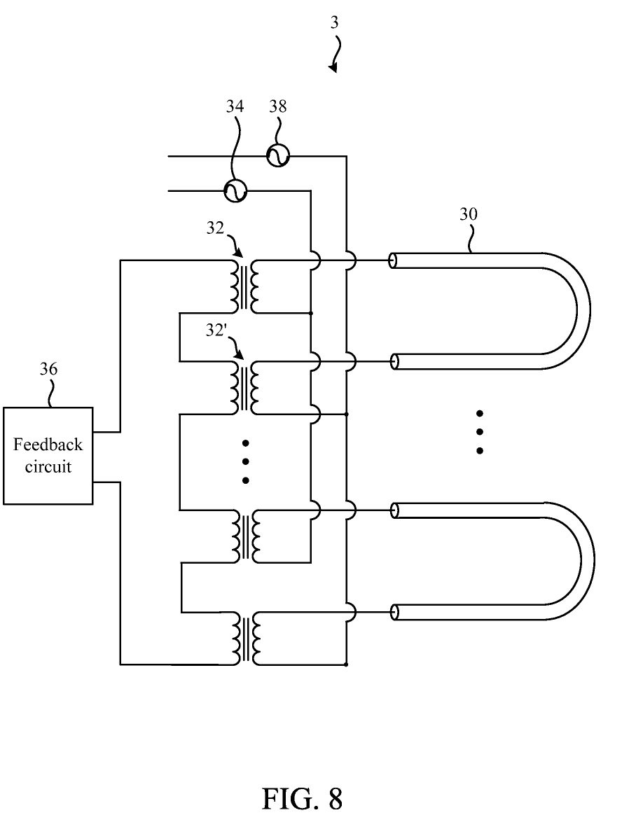

Please refer to FIG. 8. FIG. 8 is a schematic diagram illustrating the backlight module 3 according to another embodiment of the invention. As shown in FIG. 8, the difference between the embodiment and the prior embodiment is that both the first balance transformer 32 and the second balance transformer 32′ in the embodiment are set on the same side and the lighting unit 30 is U-type. In practice, the circuit frame in the embodiment is suitable for the backlight module using U-type lamps as the lightening source. Other units in the embodiment are the same as those of the above-mentioned embodiment and will not be further described here.

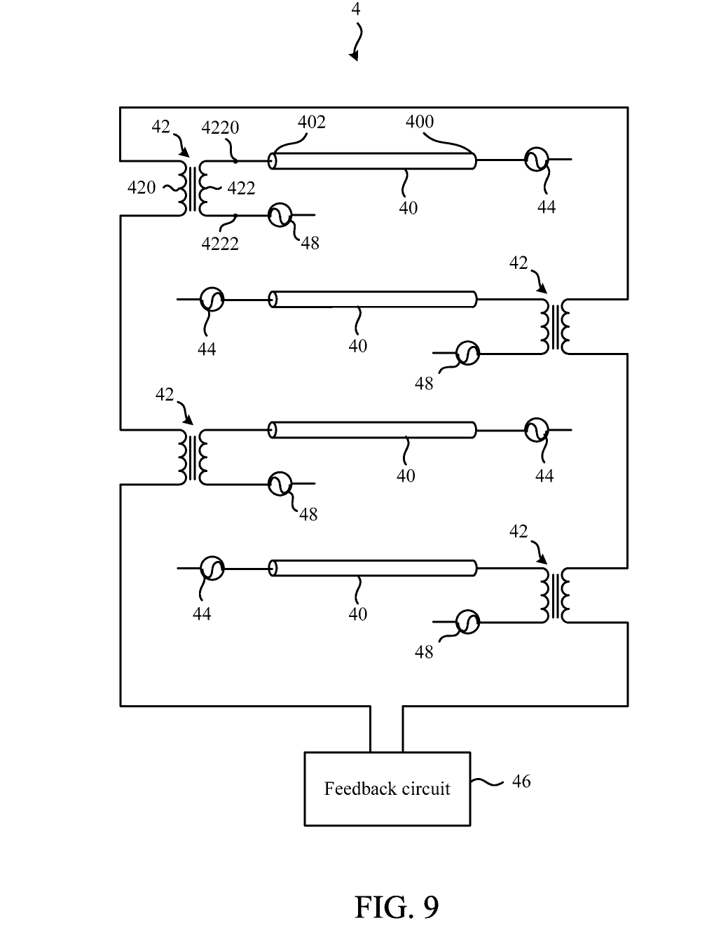

Please refer to FIG. 9. FIG. 9 is a schematic diagram illustrating a backlight module 4 according to an embodiment of the invention. As shown in FIG. 9, the backlight module 4 comprises a plurality of lighting units 40 and at least one balance transformer 42. Each of the lighting units 40 comprises a first electrode terminal 400 and a second electrode terminal 402. The at least one balance transformer 42 respectively comprises a primary-side coil 420 and a secondary-side coil 422 corresponding to the primary-side coil 422, wherein the secondary-side coil 422 further comprises a first end 4220 and a second end 4222.

In the embodiment, each of the electrode terminals 400 is coupled to the first power source 44. Each of the primary-side coils 420 of the at least one balance transformer 42 is connected to each other to form a close loop, and the close loop is further coupled to a feedback circuit 46. In addition, the first end 4220 of the secondary-side coil 422 is coupled to one of the second electrode terminals 402, and the second end 4222 is coupled to the second power source 48.

The lighting units 40 in the embodiment are staggered, i.e. the first electrode terminal 400 of a lighting unit 40 is adjacent to the second electrode terminal 402 of another lighting unit 40. In practice, the polarity of the first power source 44 is different from that of the second power source 48, i.e. if the first power source 44 provides a positive voltage, the second power source 48 provides a negative voltage for the balance transformer 42. On the other hand, if the first power source 44 provides a negative voltage, the second power source 48 provides a positive voltage for the balance transformer 42.

Compared to the prior art, the invention improves the balance circuit in the backlight module and makes the longer lighting unit to have good balance effect. Therefore, it is suitable to be used for large-scale liquid crystal display panel. Besides, the embodiments according to the invention can reduce the number of the balance transformers or use a single plate as substrate to achieve the effect of saving production cost. On the other hand, the backlight module of the invention can also further use the transformer with lower voltage endurance and smaller size as the balance transformer, and it has the effect of saving the production cost and helpful for thinning the liquid crystal display panel.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A backlight module comprising:
a plurality of lighting units, each of the lighting units comprising a first electrode terminal and a second electrode terminal, the first electrode terminals being coupled to a power source; and
at least one balance transformer coupled to at least one of the second electrode terminals, and the primary side of the at least one balance transformer being connected to each other to form a close circuit.

2. The backlight module of claim 1, wherein the close circuit is further coupled to a feedback loop.

3. The backlight module of claim 1, wherein the secondary side of the at least one balance transformer respectively comprises a first end and a second end, the first end is coupled to one of the second electrode terminals and the second end is grounded.

4. The backlight module of claim 1, wherein the power source comprises a positive polarity power source and a negative polarity power source, the first electrode terminal of a first lighting unit of the lighting units is coupled to the positive polarity power source and the first electrode terminal of a second lighting unit of the lighting units is coupled to the negative polarity power source.

5. The backlight module of claim 4, wherein the secondary side of the at least one balance transformer comprises a first end and a second end, the first end is coupled to the second electrode terminal of the first lighting unit and the second end is coupled to the second electrode terminal of the second lighting unit.

6. The backlight module of claim 4, wherein the secondary side of the at least one balance transformer comprises a first end and a second end, the first end is coupled to one of the second electrode terminals and the second end is grounded.

7. A backlight module comprising:
a plurality of lighting units, each of the lighting units comprising a first electrode terminal; and
at least one first balance transformer coupled to a first power source respectively, the primary side of the at least one first balance transformer being connected to each other to form a close circuit, and the secondary side of the at least one first balance transformer respectively comprising a first end coupled to one of the first electrode terminals.

8. The backlight module of claim 7, wherein the close circuit is further coupled to a feedback loop.

9. The backlight module of claim 7, wherein the secondary side of the at least one first balance transformer respectively comprises a second end coupled to the first power source.

10. The backlight module of claim 9, wherein each of the lighting units comprises a second electrode terminal corresponding to the first electrode terminal, and the second electrode terminals are grounded.

11. The backlight module of claim 9, wherein each of the lighting units comprises a second electrode terminal corresponding to the first electrode terminal, and the second electrode terminal coupled to a second power source, wherein the polarity of the second power source is opposite to the one of the first power source.

12. The backlight module of claim 9, further comprising at least one second balance transformer, and each of the lighting units comprising a second electrode terminal corresponding to the first electrode terminal, the secondary side of the at least one second balance transformer respectively comprising a third end and a fourth end, the third end is coupled to one of the second electrode terminals, the fourth end is coupled to a second power source, wherein the polarity of the second power source is opposite to the one of the first power sources.

13. The backlight module of claim 12, wherein the primary side of the at least one second balance transformer is connected to each other in series to form the close loop, and the close circuit is further coupled to a feedback circuit.

14. The backlight module of claim 13, wherein the lighting units are U-type lamps.

15. A backlight module comprising:
a plurality of lighting units, each of the lighting units comprising a first electrode terminal and a second electrode terminal, and the first electrode terminals being coupled to a first power source; and
at least one balance transformer comprising a primary side and a secondary side corresponding to the primary side, the primary side being connected to each other to form a close circuit, and the secondary side comprising a first end and a second end, wherein the first end is coupled to one of the second electrode terminals and the second end is coupled to a second power source.

16. The backlight module of claim 15, wherein the close circuit is further coupled to a feedback loop.

17. The backlight module of claim 15, wherein each of the lighting units comprises a first lighting unit and a second lighting unit, the first electrode terminal and the second electrode terminal of the first lighting unit being staggered with the first electrode terminal and the second electrode terminal of the second lighting unit.

18. The backlight module of claim 15, wherein the first power source is a positive polarity power source and the second power source is a negative polarity power source.

19. The backlight module of claim 15, wherein the first power source is a negative polarity power source and the second power source is a positive polarity power source.
